(19) United States
(12) Patent Application Publication
(10) Pub. No.: US 2025/0282037 A1
(43) Pub. Date: Sep. 11, 2025

(54) Hard Plastic Ring Handle Remover

(71) Applicant: Cristina Saldana, Indian Head Park, IL (US)

(72) Inventor: Cristina Saldana, Indian Head Park, IL (US)

(21) Appl. No.: 18/598,404

(22) Filed: Mar. 7, 2024

(51) Int. Cl. B25B 27/14; B65D 23/10

(52) U.S. Cl. CPC B25B 27/14; B65D 23/104

(57) ABSTRACT

Large bottles sold at big box stores, like Costco, are often joined in pairs by a handle with rings that are inserted through the top of the bottles holding them by the neck. Removing these rings to detach the bottles can be a difficult task, especially since there is little to grasp on the ring to pull it up from the neck through the cap. The Hard Plastic Ring Remover Tool was designed to leverage as little force as possible. By inserting the tip into an opening in the ring, sliding the tool down and then pressing the tool against the cap, the ring slides up and is freed from the neck. The hard plastic ring then is lifted above the cap by continuing to press down on the tool.

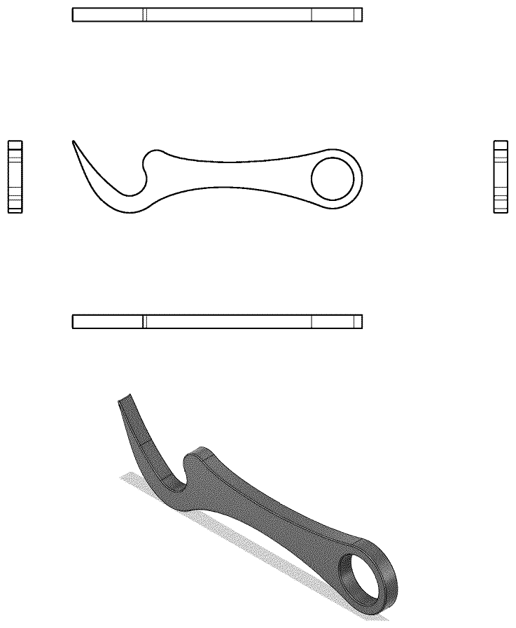

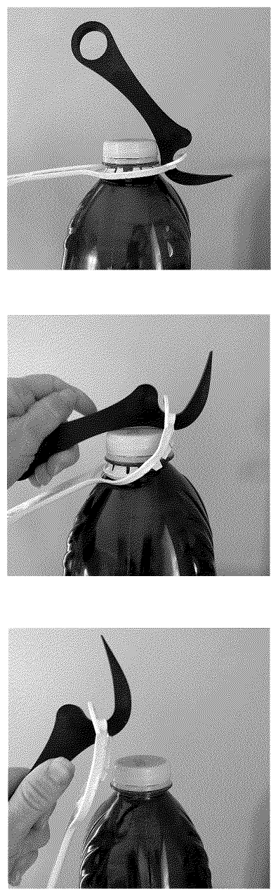

### BACKGROUND OF THE INVENTION

Removal of disposable hard plastic ring handles from bottles presented in pairs at big box stores discussed herein. Currently, there are no tools specifically designed to remove these disposable ring handles, which are difficult to remove by hand, requiring a lot of force. Accordingly, there is a need for a tool that leverages less force to safely and easily remove these disposable plastic ring handles.

### SUMMARY OF THE INVENTION

The Hard Plastic Ring Handle Remover Tool is designed to be inserted in a tab of the disposable ring handle, then, leveraging against the cap, push down on the tool, pulling the ring up and releasing it from the bottle. This tool was designed to best leverage a minimum amount of force without risking slipping or injury. This tool was designed to help people with hand-strength issues.

### BRIEF DESCRIPTION OF DRAWINGS

Drawings presented show the design views and use.

### DETAILED DESCRIPTION OF THE INVENTION

The Hard Plastic Ring Handle Remover Tool was designed to be held and used by hand. Has a long-arched point on one end and a hole in the other. The long-arched point has a length and a curvature necessary to reach the disposable ring's tab while inserting from above pointing out and next to the cap. The tool's dimensions make it comfortable to use by adults and youth. The hole on one end is designed to hang the tool in a convenient spot. The protrusion opposite the long-arched point aids in preventing sliding the tool too far into the ring at any time during removal of the ring.

Tool can be 3d printed in thermoplastic or produced in metal.

1. A manual tool to remove disposable hard plastic rings or handles from bottles.

2. A design for 3d printing tool to remove disposable hard plastic rings or handles from bottles.
